(19) United States
(12) Patent Application Publication
(10) Pub. No.: US 2026/0185881 A1
(43) Pub. Date: Jul. 2, 2026

(54) OBJECT TEMPERATURE MONITORING APPARATUS AND THERMISTOR MODULE FOR USE THEREWITH

(71) Applicant: UBICQUIA, INC., FORT LAUDERDALE, FL (US)

(72) Inventors: Patrick Stuart Claeys, Weston, FL (US); Ivan Quiroz, Dallas, TX (US)

(21) Appl. No.: 19/438,551

(22) Filed: Dec. 31, 2025

Related U.S. Application Data
(60) Provisional application No. 63/741,007, filed on Dec. 31, 2024.

(51) Int. Cl. G01K 7/22; G01K 1/08; G01K 1/143; G01K 1/20; H01F 27/40

(52) U.S. Cl. CPC G01K 7/22; G01K 1/08; G01K 1/143; G01K 1/20; H01F 27/402; H01F 2027/406

(57) ABSTRACT

A object temperature monitoring apparatus includes a first housing configured for attachment to an object, such as an electrical distribution transformer, and a thermistor module coupled to or integrated with the first housing. The thermistor module includes a second housing and a thermistor. The second housing includes an elastic boot and a thermistor compartment adjacent to the elastic boot. The thermistor is positioned within the thermistor compartment and oriented to sense a temperature of the object when the first housing is attached to the object and the thermistor compartment is placed against a surface of the object. The elastic boot may be constructed to allow movement of the thermistor compartment when it is compressed against the surface of the object to enable the thermistor compartment to form a seal against the object's surface to prevent ambient air from affecting temperature measurements.

### CROSS-REFERENCE TO RELATED APPLICATIONS

The present application claims the benefit of and priority upon U.S. Provisional Patent Application No. 63/741,007, which was filed on Dec. 31, 2024, and is incorporated herein by this reference as if fully set forth herein.

### TECHNICAL FIELD

The present disclosure generally relates to thermistor based fault monitoring and detection methods and systems for heat-generating objects, such as electrical distribution transformers. More particularly, but not exclusively, the present disclosure relates to an object temperature monitoring apparatus and a thermistor module for use therewith.

### BACKGROUND

Distribution transformers are parts of the power system infrastructure. The power system infrastructure includes power lines, transformers and other devices for power generation, power transmission, and power delivery. A power source generates power, which is transmitted along high voltage (HV) power lines for long distances. Typical voltages found on HV transmission lines range from 69 kilovolts (kV) to in excess of 800 kV. The power signals are stepped down to medium voltage (MV) power and then stepped down further to low voltage (LV) levels at distribution transformers. LV power lines typically carry power signals having voltages ranging from about 100 V to about 600 V to customer premises.

In the United States local distribution transformers typically feed anywhere from one to ten homes, depending upon the concentration of the customer premises in a particular area. A power distribution system for a given area may include many distribution transformers. Thus, the monitoring costs, replacement costs and maintenance costs for distribution transformers can be a significant factor in the cost of power distribution.

A number of factors adversely affect the life and operation of a distribution transformer. One challenge to the efficient maintenance of a distribution transformer is that an overload cannot be detected and monitored directly. An overload may be inferred from load flow models and physical properties of the transformer, such as the temperature of the transformer housing's exterior surface. Other events that may occur at the power transformer can affect the life, operation, or viability of the distribution transformer. Distribution transformers monitors (DTMs) are already used to monitor some transformers in some power distribution systems. Although DTMs monitor a variety of transformer properties and parameters, monitoring device improvements need to continue to be made to improve monitoring accuracy.

All of the subject matter discussed in the Background section is not necessarily prior art and should not be assumed to be prior art merely as a result of its discussion in the Background section. For example, the recognition of problems in the prior art should not be treated as prior art unless expressly stated to be so.

### SUMMARY

In some exemplary embodiments of the present disclosure, an object temperature monitoring apparatus includes a first housing configured for attachment to an object and a thermistor module coupled to or integrated with the first housing. The thermistor module includes a second housing and a thermistor. The second housing includes an elastic boot and a thermistor compartment adjacent to the elastic boot. The thermistor is positioned within the thermistor compartment of the second housing and oriented to sense a temperature of the object when the first housing is attached to the object and the thermistor compartment is placed against a surface of the object.

In some exemplary embodiments of the object temperature monitoring apparatus, the thermistor compartment of the second housing further includes a window oriented for placement against the surface of the object. The window may be clear, translucent, or transparent.

In some exemplary embodiments of the object temperature monitoring apparatus, the thermistor compartment of the second housing is filled with, and the thermistor is set within, an elastomeric potting that provides environmental protection, thermal conduction, and electrical isolation for the thermistor.

In some exemplary embodiments of the object temperature monitoring apparatus, the elastic boot of the second housing is constructed to allow movement of the thermistor compartment when the thermistor compartment is compressed against the surface of the object to enable the thermistor compartment to form a seal against the surface of the object to prevent ambient air from affecting temperature measurements.

In some exemplary embodiments of the present disclosure, a thermistor module includes a conforming housing and a thermistor. The housing includes an elastic boot and a thermistor compartment adjacent to the elastic boot. The thermistor is positioned within the thermistor compartment of the conforming housing and oriented to sense a temperature of an object against which the thermistor compartment is to be placed. The thermistor compartment of the conforming housing may include a window oriented for placement against a surface of the object. The window may be clear, translucent, or transparent.

In some exemplary embodiments of the thermistor module, the thermistor compartment may be filled with, and the thermistor set within, an elastomeric potting that provides environmental protection, thermal conduction, and electrical isolation for the thermistor.

In some exemplary embodiments of the thermistor module, the thermistor compartment provides an auto-sealing function under compression to prevent ambient air from affecting temperature measurements. For example, in some exemplary embodiments, the elastic boot is constructed to allow movement of the thermistor compartment when compressed against the object to enable the thermistor compartment to form a seal against a surface of the object to prevent ambient air from affecting temperature measurements.

In some exemplary embodiments of the thermistor module, the thermistor module also includes cabling to couple the thermistor to electrical circuitry in a monitoring device in or with which the thermistor module is used.

In some exemplary embodiments of the present disclosure, a transformer monitoring apparatus includes a first housing configured for attachment to an electrical distribution transformer and a thermistor module coupled to or integrated with the first housing. For example, the first housing may be configured for magnetic attachment to an exterior surface of the tank wall of the electrical distribution transformer. The thermistor module includes a second housing and a thermistor. The second housing includes an elastic boot and a thermistor compartment adjacent to the elastic boot. The thermistor is positioned within the thermistor compartment of the second housing and oriented to sense a temperature of the electrical distribution transformer when the first housing is attached to the electrical distribution transformer and the thermistor compartment is placed against a surface of the electrical distribution transformer.

In some exemplary embodiments of the transformer monitoring apparatus, the thermistor compartment of the second housing includes a window oriented for placement against the surface of the electrical distribution transformer. The window may be clear, translucent, or transparent.

In some exemplary embodiments of the transformer monitoring apparatus, the thermistor compartment of the second housing is filled with, and the thermistor is set within, an elastomeric potting that provides environmental protection, thermal conduction, and electrical isolation for the thermistor.

In some exemplary embodiments of the transformer monitoring apparatus, the thermistor compartment of the second housing provides an auto-sealing function under compression to prevent ambient air from affecting temperature measurements. For example, in some exemplary embodiments, the elastic boot of the second housing is constructed to allow movement of the thermistor compartment when compressed against the surface of the electrical distribution transformer to enable the thermistor compartment to form a seal against the surface of the electrical distribution transformer to prevent ambient air from affecting temperature measurements.

In some exemplary embodiments of the transformer monitoring apparatus, the thermistor module further includes cabling running from the thermistor through at least the elastic boot to couple the thermistor to electrical circuitry in the first housing.

In some exemplary embodiments, a thermistor module for use in an electronic device that monitors temperature of an object includes a conforming housing and a thermistor. In such embodiments, the conforming housing includes an elastic boot and a thermistor compartment adjacent to the elastic boot. The thermistor is positioned within the thermistor compartment of the conforming housing and oriented to sense a temperature of an object against which the thermistor compartment is placed. The thermistor compartment may include a window, which may be transparent or translucent, wherein the window of the thermistor compartment is placed against a surface of the object being monitored.

In some embodiments, a thermistor module can include a thermistor, a conforming housing that includes an elastic boot, and a thermistor electronic assembly set within an upper portion (e.g., a thermistor compartment) of the conforming housing using elastomeric potting that provides environmental protection, thermal conduction, and electric isolation for the thermistor.

In some embodiments, the upper portion of the conforming housing further includes a transparent or translucent window.

In some embodiments, the upper portion of the conforming housing provides an auto-sealing function under compression to prevent ambient air from affecting temperature measurements.

In some embodiments, the thermistor module is arranged and configured to integrate with a back side of a distribution transformer monitor.

In some embodiments, the thermistor module is arranged and configured to integrate with a side of a distribution transformer monitor that is mounted to a distribution transformer where the thermistor module seals to a housing of the distribution transformer.

In some embodiments, the thermistor module is arranged and configured to integrate with a back side of a distribution transformer monitor that is magnetically mounted to a distribution transformer where the thermistor module seals to a housing of the distribution transformer.

In some embodiments, an electrical or electronic device can include a housing, and a thermistor module coupled to or integrated with housing. The thermistor module can include a thermistor, a conforming housing that includes an elastic boot, and a thermistor electronic assembly set within an upper portion of the conforming housing using elastomeric potting that provides environmental protection, thermal conduction, and electric isolation for the thermistor forming a portion of the thermistor electronic assembly.

In some embodiments, the electrical device is a distribution transformer monitor.

In some embodiments, the electrical device is a distribution transformer.

In some embodiments, the upper portion of the conforming housing further includes a transparent or translucent window.

In some embodiments, the upper portion of the conforming housing provides an auto-sealing function under compression between the housing for the electrical device and the thermistor module to prevent ambient air from affecting temperature measurements.

In some embodiments, the electrical device is a distribution transformer monitor and the thermistor module is arranged and configured to integrate with a back side of the distribution transformer monitor.

In some embodiments, the electrical device is a distribution transformer monitor and the thermistor module is arranged and configured to integrate with a side of the distribution transformer monitor that is mounted to a distribution transformer where the thermistor module seals to a housing of the distribution transformer.

In some embodiments, the electrical device is a distribution transformer monitor and wherein the thermistor module is arranged and configured to integrate with a back side of the distribution transformer monitor magnetically mounted to a distribution transformer where the thermistor module seals to a housing of the distribution transformer.

In some embodiments, the thermistor module further includes a communication interface, a non-transitory memory storing processor-executable instructions, and a processor, operably coupled to the thermistor, the communication interface, and the memory. The processor can be operable in accordance with the processor-executable instructions to determine whether output voltage or data from the thermistor substantially matches one of a plurality of thermistor output signatures representing corresponding event signatures and communicate via the communication interface an alert to a remote computing device when the output substantially matches one of the plurality of thermistor output signatures.

In some embodiments, a distribution transformer system can include a housing for a distribution transformer of the distribution transformer system, a thermistor module coupled to or integrated with the distribution transformer. The thermistor module can include a thermistor, a conforming housing that includes an elastic boot, and a thermistor electronic assembly set within an upper portion of the conforming housing using elastomeric potting that provides environmental protection, thermal conduction, and electric isolation for the thermistor forming a portion of the thermistor electronic assembly.

In some embodiments, the upper portion of the conforming housing of the distribution transformer system further includes a transparent or translucent window.

In some embodiments, the upper portion of the conforming housing of the distribution transformer system provides an auto-sealing function under compression between the housing for the distribution transformer and the thermistor module to prevent ambient air from affecting temperature measurements.

In some embodiments, the thermistor module of the distribution transformer system is arranged and configured to integrate with a back side of a distribution transformer monitor magnetically mounted to the distribution transformer where the thermistor module seals to a housing of the distribution transformer.

In some embodiments, the thermistor module of the distribution transformer system further includes a communication interface, a non-transitory memory storing processor-executable instructions, and a processor, operably coupled to the thermistor, the communication interface, and the memory. The processor can be operable in accordance with the processor-executable instructions to determine whether output voltage or data from the thermistor substantially matches one of a plurality of thermistor output signatures representing corresponding event signatures and communicate via the communication interface an alert to a remote computing device when the output substantially matches one of the plurality of thermistor output signatures.

### BRIEF DESCRIPTION OF THE DRAWINGS

Non-limiting and non-exhaustive embodiments are described with reference to the following drawings, wherein like reference numerals refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings.

FIG. 1A illustrates a thermistor module including a thermistor, in accordance with exemplary embodiments of the present disclosure.

FIG. 1B illustrates a cut view of the thermistor module of FIG. 1A along lines 1B-1B, where the thermistor module is mounted to or integrated with a transformer monitoring apparatus, such as a DTM, in accordance with exemplary embodiments of the present disclosure.

FIG. 2 illustrates a thermistor module mounted against a tank wall of a pad mounted distribution transformer, in accordance with exemplary embodiments of the present disclosure.

FIG. 3 illustrates a thermistor module mounted against a tank wall of another pad mounted distribution transformer, in accordance with exemplary embodiments of the present disclosure.

FIG. 4 illustrates a transformer monitoring apparatus that includes a thermistor module mounted against a tank wall of a pole-mounted or aerial distribution transformer, in accordance with exemplary embodiments of the present disclosure.

FIG. 5A illustrates a front view of an exemplary transformer monitoring apparatus, in accordance with exemplary embodiments of the present disclosure.

FIG. 5B illustrates a rear view of the exemplary transformer monitoring apparatus of FIG. 5A showing a thermistor module integrated therewith or mounted thereon or thereto, in accordance with exemplary embodiments of the present disclosure.

FIG. 5C illustrates an enlarged rear view of the transformer monitoring apparatus of FIGS. 5A and 5B showing an exemplary location for the thermistor module, accordance with exemplary embodiments of the present disclosure.

FIG. 6 illustrates a block diagram of an exemplary electrical power distribution system including several pad mounted distribution transformers similar to the distribution transformer of FIG. 3 and each with an installed transformer monitoring apparatus of FIG. 5B, in accordance with exemplary embodiments of the present disclosure.

FIG. 7 is a block diagram of a transformer monitoring apparatus that includes the thermistor module of FIGS. 1A and 1B and is placed such that the housing of the thermistor module is in a sealed engagement against an exterior surface of a distribution transformer, in accordance with exemplary embodiments of the present disclosure.

FIG. 8 is a block diagram of a transformer monitoring apparatus that is connected to the thermistor module of FIGS. 1A and 1B by a cable, where the thermistor module is not mounted to or integrated with the transformer monitoring apparatus and the housing of the thermistor module is in a sealed engagement against an exterior surface of a distribution transformer, in accordance with exemplary embodiments of the present disclosure.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. Also in these instances, well-known structures may be omitted or shown and described in reduced detail to avoid unnecessarily obscuring descriptions of the embodiments.

In some embodiments, a distribution transformer monitor or DTM with thermistor module installed within a pad-mounted transformer or installed on a pole-mounted transformer is used to detect thermal events within or affecting the transformer. One embodiment can include programming an onboard processor with one or more thermistor output data signatures representing the signatures for the particular events, such as thermal events resulting from arcing across the primary and/or secondary terminals and ground, fire within the hatch, and correspondingly sending alarms (or taking appropriate and available remediation actions) if the events are detected. An alternative embodiment can include programming a server with thermistor output data signatures representing the particular events, and sending raw thermistor output data to the server for event analysis and alarm generation. A priority schedule can also be set for various types of alarms (e.g., arcing or fire versus mild thermal deviations consistent with ambient temperatures). Other embodiments can combine the thermistor output data with other sensor data to make appropriate assessments and alarms accordingly.

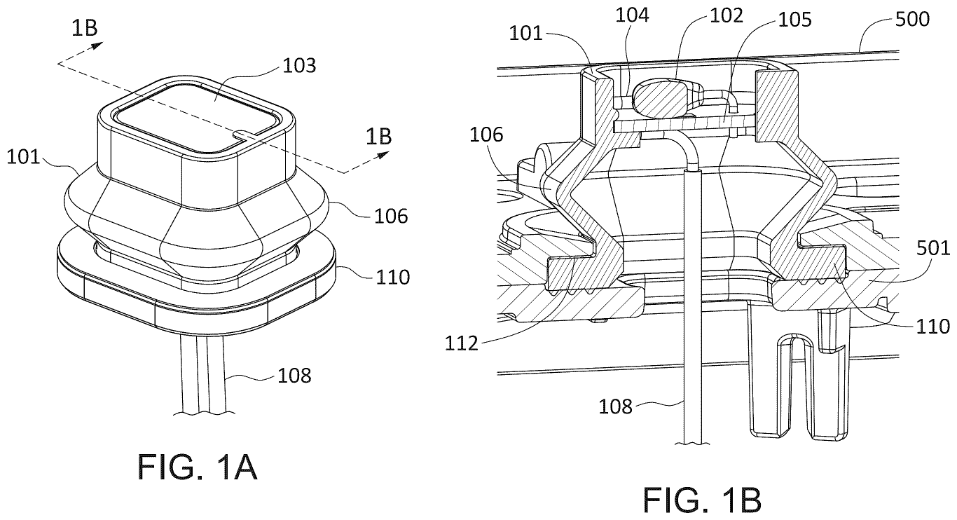

In some embodiments and referring to FIGS. 1A and 1B, the boot-shape of a thermal module 100 and its material properties provide the ability to conform to any tank geometry (curved, flat, imperfect). The boot-shaped portions and overall design creates an environmentally isolated temperature sensor that is significantly less affected by sun, rain, wind, or other external environmental conditions. Data records taken for this design appears more accurate and predictable than existing oil temperature sensors on distribution transformer monitors in all known test scenarios. Use of elastomeric potting provides a means of environmental protection, thermal conduction, and electric isolation for the embedded thermistor. The elastomeric material and its properties are also important to the systems ability to conform to varying tank geometries. In some embodiments, the elastic boot (or silicone boot) creates a constant load/force against the tank which provides consistent temperature measurements over the life of the product at both hot and cold extremes. The boot in combination with potting material, housing adhesive, and compression plate maintains seal (such as an IP67 seal) for the product. This solution is more cost effective than existing pressure transducers with embedded temperature sensors.

Referring to FIGS. 1A and 1B, a thermistor module 100 is shown alone and as mounted to or integrated with a transformer monitoring apparatus, such as a DTM 500, in accordance with exemplary embodiments of the present disclosure. In some embodiments, a thermistor module 100 can more specifically include a thermistor 102, a conforming housing 101 that includes an elastic boot 106, and a thermistor electronic assembly 105 set within an upper portion of the conforming housing 101 using elastomeric potting 104 that provides environmental protection, thermal conduction, and electric isolation for the thermistor forming a portion of the thermistor electronic assembly. The thermistor module 100 can also include cabling 108 coupled to the thermistor electronic assembly as further illustrated in cut view 1B-1B of FIG. 1B. The cabling can provide power and data signaling between the thermistor module and other devices (such as a DTM or a remote computer monitoring system). The cut view further illustrates how a base portion 110 of the conforming housing 101 can be mounted within an opening or other recessed area of a distribution transformer 500 and more particularly a retaining wall 501 of the transformer 500 (or of a DTM back wall) configured to mount and retain the thermistor module 100 using a curve portion or lip 112 mounted on such retaining wall 501.

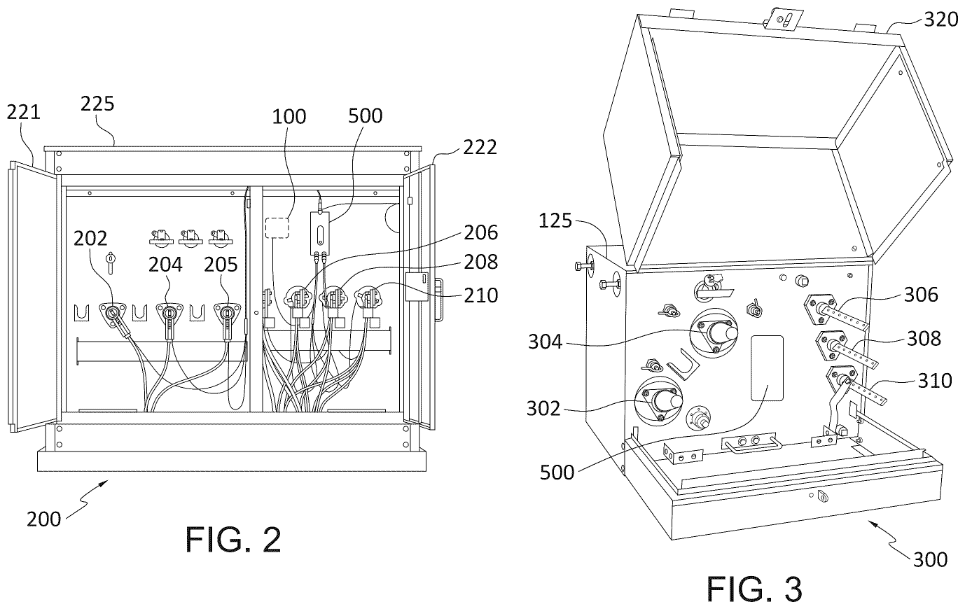

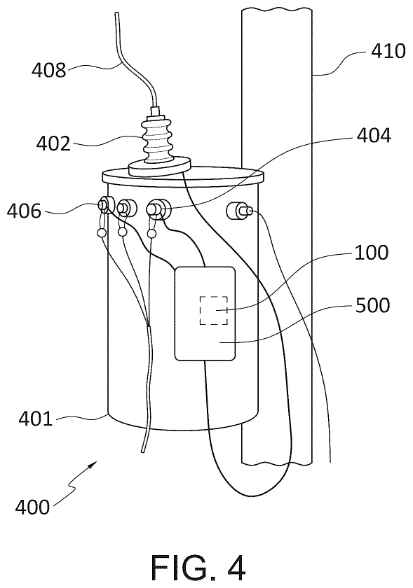

FIGS. 2 and 3 illustrate the thermistor module 100 or a transformer monitoring apparatus 500 including the thermistor module 100 mounted to or against a tank wall of two exemplary pad mounted distribution transformers 200, 300, in accordance with exemplary embodiments of the present disclosure. As illustrated in FIG. 2, the thermistor module 100 can be mounted directly on an interior wall of the pad-mounted transformer 200 that is perpendicular to the voltage inputs and outputs or an interior wall that might be flush with the wall with the voltage inputs and outputs as shown in the transformer 300 of FIG. 3. The pad mounted distribution transformer 200 can generally include a high voltage primary input 202, a high voltage primary output 204 or 205, and the lower voltage secondary outputs 206, 208 and 210. Such a transformer 200 can be housed in a housing 225 having openable and closeable doors 221 and 222 as shown in FIG. 2. The transformer 200 can further include a separate DTM 500 mounted on the transformer 200 that is independent of the thermistor module 100. Again, the thermistor module 100 and DTM in various embodiments can operate in tandem or operate separately.

The pad mounted distribution transformer 300 of FIG. 3 can generally include a high voltage primary input 302, a high voltage primary output 304, and the lower voltage secondary outputs 306, 308, 310. Such a transformer 300 can be housed in a housing 325 having a hood 320 as shown. The hood 320 provides easy access to the inputs, outputs and other components for installation and maintenance purposes. The transformer 300, in some embodiments, can optionally include the DTM (not shown in FIG. 3) as noted above with respect to FIG. 2.

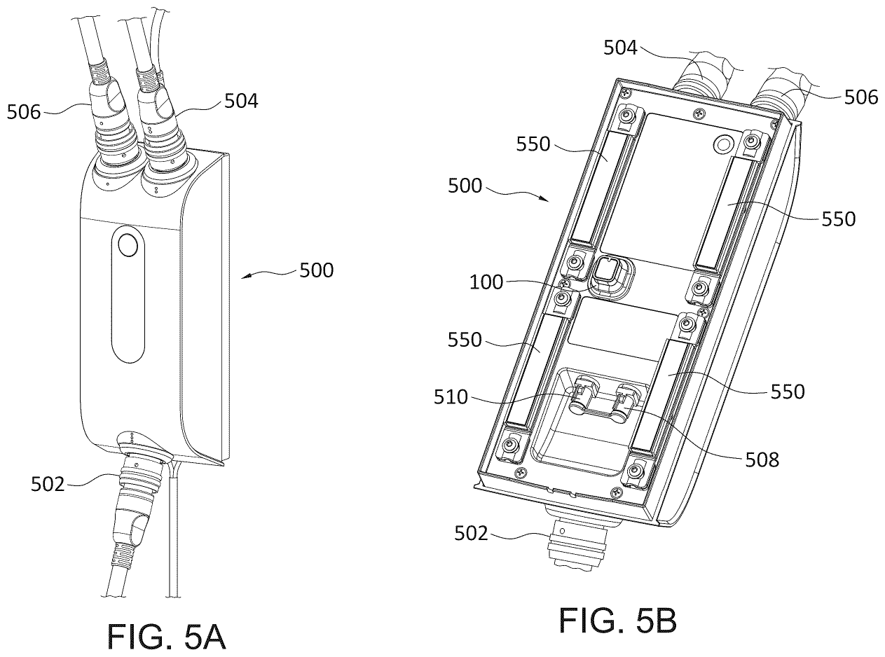

FIG. 4 illustrates a transformer monitoring apparatus 500 that includes the thermistor module 100 mounted against a tank wall of a pole-mounted or aerial distribution transformer 400, in accordance with exemplary embodiments of the present disclosure. As illustrated in FIG. 4, the thermistor module 100 can also be alternatively mounted directly on a curved wall of the pole-mounted transformer 400. The pole mounted distribution transformer 400 can be mounted on a pole 410 and can generally include a high voltage primary input 408 and corresponding bushing 402, lower voltage secondary outputs 404 and 406 as well as other outputs. Such a transformer 400 can be housed in a tank housing 401 as shown. The transformer 400 can further include a separate DTM (not shown) mounted on the transformer 400 that is independent of the DTM. In other embodiments, the thermistor module is incorporated as part of the DTM.

The thermistor module 100 can be mounted on a power transformer directly or indirectly using a distribution transformer monitor (DTM) having the thermistor module embedded or mounted thereon forming a part of an apparatus or system or method for detecting faults or events within the power transmission system or more particularly within a specific power transformer in the power transmission system is shown. More particularly, such a system can detect events or other anomalies based on signals obtained or derived from the thermistor module or in some embodiments from the a combination of the thermistor module and other sensors such as a Rogowski coil or coils, temperature sensors, optical sensors or other sensors that may be part of a DTM or in communication with the DTM or in communication with a remote computer system in communication with the DTM and other sensors. Note that the parameter sensors contemplated within the embodiments are not limited to a thermistor module as detailed here, but can include other sensors such as cameras, current transformers or voltmeters or other devices that measure current, voltage, impedance, Power Factor, or other parameters useful in detecting potential faults or conditions requiring further review, monitoring, maintenance, repair, replacement or other desirable interventions prolonging the efficient useful life of such components and systems being monitored.

In some embodiments, referring again to FIGS. 1A and 1B, the upper portion of the conforming housing 101 further includes a transparent or translucent window 103. In some embodiments, no window may be needed as the conforming housing and a wall of a DTM or transformer will provide a sealed area upon compression.

In some embodiments, the upper portion of the conforming housing 101 provides an auto-sealing function under compression to prevent ambient air from affecting temperature measurements. For example, the conforming housing 101 can be compressed between a DTM and a tank wall of a pad mounted distribution transformer or a tank wall of a pole-mounted transformer.

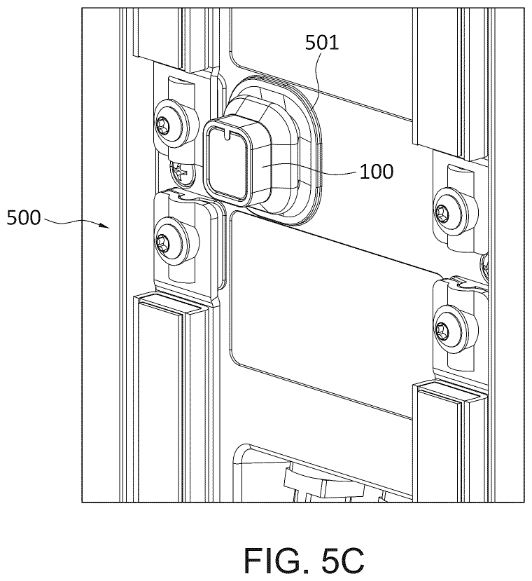

In some embodiments, the thermistor module 100 is arranged and configured to integrate with a back side of a distribution transformer monitor such as DTM 500 shown in FIGS. 5A, 5B, and 5C. FIG. 5A illustrates a front view of an exemplary transformer monitoring apparatus 500, in accordance with exemplary embodiments of the present disclosure and FIG. 5B illustrates a rear view of the exemplary transformer monitoring apparatus 500 showing the thermistor module 100 integrated therewith or mounted thereon or thereto. FIG. 5C illustrates an enlarged rear view of the transformer monitoring apparatus 500 showing an exemplary location for the thermistor module 100.

The DTM 500 can attach to surfaces of different configurations such as the tank of a pole-mounted transformer or a wall of a pad-mounted transformer. The DTM 500 can have fixed or rotatable magnet support brackets or assemblies 550 that easily mount to the curved surface of the cylindrical shaped tank or any other surface as needed. In particular, the primary high voltage input port or line 502 can couple to the primary high voltage side bushing of a transformer and the secondary low voltage input port and/or line(s) 504 and 506 can couple to the respective secondary low voltage side bushings of a transformer. Other line signals can be coupled to communication ports 508 and 510 (see FIG. 5B) in order to enable remote monitoring of the transformer system. In FIG. 5C, the thermistor module 100 is shown mounted on the DTM 500 using the retaining wall 501 of the DTM 500.

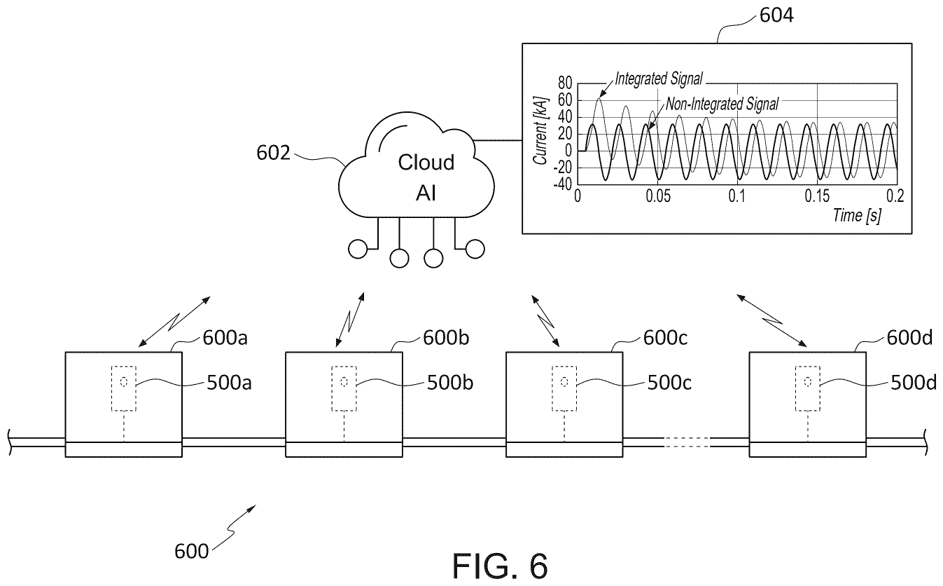

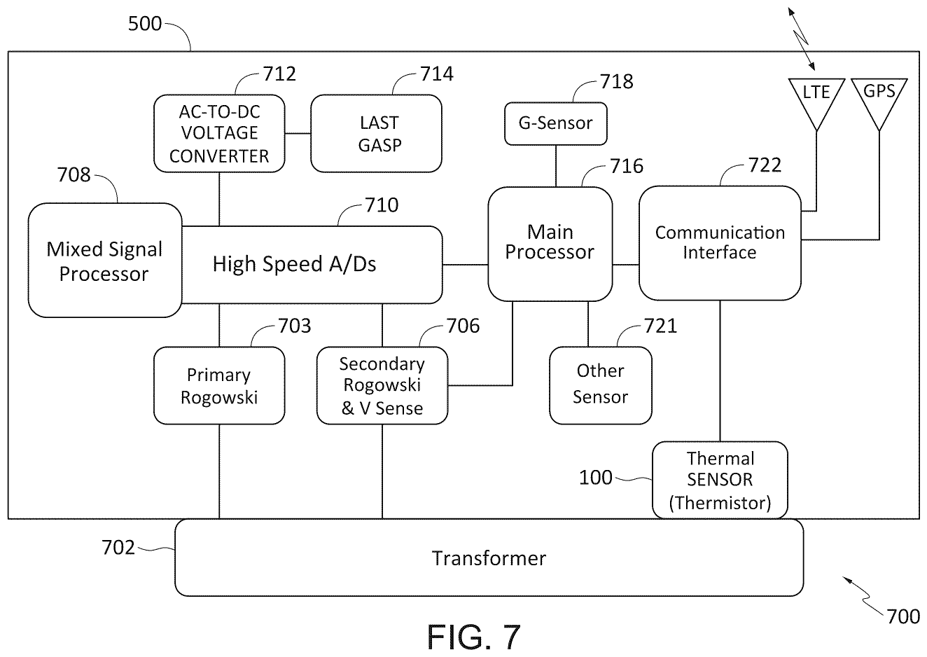

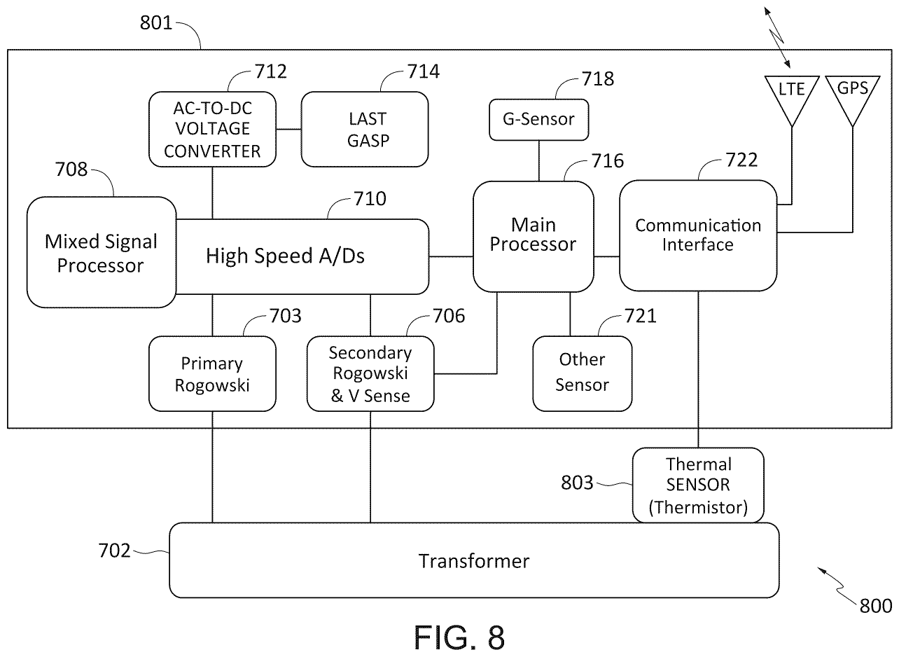

In some embodiments, the thermistor module 100 is arranged and configured to integrate with a side of a distribution transformer monitor 500 that is further mounted to a distribution transformer (such as transformer 600a of FIG. 6 or transformer 702 of FIG. 7 where the thermistor module seals to a housing of the distribution transformer as shown.

In some embodiments, the thermistor module 100 is arranged and configured to integrate with a back side of a distribution transformer monitor 500 as shown in FIG. 5C that can be magnetically mounted to a distribution transformer (using magnets 550 as shown in FIG. 5B) where the thermistor module 100 seals to a housing of the distribution transformer(s) (600a-d) in FIG. 6 or 702 in FIG. 7B.

In some embodiments, an electrical device (such as a transformer or DTM) can include a housing for the electrical device, and a thermistor module 100 coupled to or integrated with the electrical device. The thermistor module 100 (as shown in FIGS. 1A and 1B) can include a thermistor 102, a conforming housing 101 that includes an elastic boot 106, and a thermistor electronic assembly 105 set within an upper portion of the conforming housing using elastomeric potting 104 that provides environmental protection, thermal conduction, and electric isolation for the thermistor forming a portion of the thermistor electronic assembly.

In some embodiments, the electrical device is a distribution transformer monitor such as pad mounted transformers 200 of FIG. 2 or 300 of FIG. 3 or such as pole mounted transformer 400 of FIG. 4.

In some embodiments, the upper portion of the conforming housing 101 further includes a transparent or translucent window 104.

In some embodiments, the upper portion of the conforming housing provides an auto-sealing function under compression between the housing 101 for the electrical device and the thermistor module 100 to prevent ambient air from affecting temperature measurements.

In some embodiments, the electrical device is a distribution transformer monitor 500 as shown in FIG. 5C and the thermistor module 100 is arranged and configured to integrate with a back side of the distribution transformer monitor 500.

In some embodiments, the electrical device is a distribution transformer monitor 500 and the thermistor module 100 is arranged and configured to integrate with a side of the distribution transformer monitor 500 that is mounted to a distribution transformer (200, 300 or 400 of FIG. 2, 3 or 4 respectively) where the thermistor module 100 seals to a housing of the distribution transformer.

In some embodiments, the electrical device is a distribution transformer monitor 500 and the thermistor module 100 is arranged and configured to integrate with a back side of the distribution transformer monitor magnetically mounted (using magnets 550 as shown in FIG. 5B) to a distribution transformer (200, 300 or 400 of FIGS. 2-4 respectively) where the thermistor module seals to a housing of the distribution transformer.

In some embodiments, (as shown in FIGS. 7A and 7B), the thermistor module can further include a communication interface, a non-transitory memory storing processor-executable instructions, and a processor, operably coupled to the thermistor, the communication interface, and the memory. The processor can be operable in accordance with the processor-executable instructions to determine whether output voltage or data from the thermistor substantially matches one of a plurality of thermistor output signatures representing corresponding event signatures and communicate via the communication interface an alert to a remote computing device when the output substantially matches one of the plurality of thermistor output signatures.

In some embodiments, a distribution transformer system 700 can include a housing for a distribution transformer 702 of the distribution transformer system, a thermistor module 720 coupled to or integrated with the distribution transformer 702. In the system 700 shown in FIG. 7B, the thermistor module 720 can be considered part of the DTM and sandwiched or pressed against a wall of the transformer 702.

As discussed above with respect to FIGS. 1A and 1B, the thermistor module can include a thermistor, a conforming housing that includes an elastic boot, and a thermistor electronic assembly set within an upper portion of the conforming housing using elastomeric potting that provides environmental protection, thermal conduction, and electric isolation for the thermistor forming a portion of the thermistor electronic assembly.

In some embodiments, the upper portion of the conforming housing of the distribution transformer system further includes a transparent or translucent window.

In some embodiments, the upper portion of the conforming housing of the distribution transformer system 700 provides an auto-sealing function under compression between the housing for the distribution transformer and the thermistor module to prevent ambient air from affecting temperature measurements.

In some embodiments as illustrated in FIGS. 7A and 7B, the thermistor module 720 of a distribution transformer system 700 is arranged and configured to integrate with a back side of a distribution transformer monitor 704 mounted (magnetically or otherwise) to the distribution transformer 702 where the thermistor module 720 seals to a housing of the distribution transformer 702.

In some embodiments, the thermistor module 720 of the distribution transformer system 700 further includes a communication interface 722, a non-transitory memory storing processor-executable instructions, and a processor 716, operably coupled to the thermistor of the thermistor module 720, the communication interface, and the memory. The processor 716 can be operable in accordance with the processor-executable instructions to determine whether output voltage or data from the thermistor substantially matches one of a plurality of thermistor output signatures representing corresponding event signatures and communicate via the communication interface 722 an alert to a remote computing device when the output substantially matches one of the plurality of thermistor output signatures.

The distribution transformer monitor (DTM) 700 as shown in FIGS. 7A and 7B is a specialized hardware device that collects and measures information relative to electricity passing into and through a distribution transformer. The DTM 700 in accordance with the embodiments can also include the thermistor module 720 or operatively couple with a separate thermistor module 720. The embodiments herein and such DTM systems can leverage each other or in some instances be incorporated into each other. The DTM is typically a retrofit onto a pole top or pad mount transformer. A pole top (above ground) or pad mount (below ground) transformer commonly powers anywhere from five to eight homes in the United States and is the last voltage transition in stepping down voltage before it gets to the home or business. Standard positioning of DTM devices occurs at the transformer bushings, but sometimes they are attached directly onto the secondary electricity lines. DTM devices commonly consist of highly accurate non-piercing or piercing sensors, onboard communications modules to transmit information, and a power supply provision. The DTM device reports to a collection engine, and/or existing SCADA/MDM system where relevant transformer data and other data (such as the raw optical sensor information or information derived therefrom) is stored and presented to a user. Furthermore, analytics platforms are oftentimes employed to interpret the information being captured and reported by the DTM.

The DTM 700 can further include Rogowski coils 703 on the respective primary high voltage lines of the transformer and can provide additional information for analysis and fault detection in addition to the existing DTM data telemetry collection. The DTM 700 can also include probes 706 applied to the secondary winding outputs (low voltage side) respectively of the transformer.

Due to the interior locations of the DTMs 500a, 500b, 500c, 500d in corresponding transformers 600a, 600b, 600c, 600d in a distribution grid 600 as shown in FIG. 6, the DTMs may present real-time and/or historical information about a particular transformer upon which it is hosted, in addition to creating a vital ongoing information access point within a grid architecture. The DTMs can use an antenna connection and corresponding antenna (as shown in FIGS. 7A and 7B) to transmit such information to a remote computing device via a cloud 602 network that can be a cloud AI that can provide analytics with respect to the grid and the components therein on a user interface 604.

As contemplated with the use of the Rogowski coils in the embodiments herein, DTM deployments with the thermistor module can be strategically and sparingly positioned within a grid to only be included in some transformers or be comprehensively positioned within each transformer to reveal critical data for each specific transformer.

The embodiments herein can have their own communication links but could also leverage the existing Remote Over-The-Air (OTA) capabilities supported by certain DTM devices. This OTA capability, when supported, allows the operator to perform remote analysis as well as configuration updates of the DTM device(s) (or the Rogowski coil related monitoring equipment or the optical sensors) without the need for costly truck rolls or unit replacement. By supporting OTA Firmware updates/upgrades, providers can progressively broaden and deepen the suite of data points captured by the DTM device and or other devices operating independent of the DTM device.

Referring again to the power transmission system 600 of FIG. 6, the embodiments herein using the parameter sensor(s) (in the form of Rogowski coils on the primary conductors, the thermistor modules, and other sensors that may be included in a DTM 500a, 500b, 500c, 500d) also enables an artificial intelligence (AI) based fault location and mode analysis system using a cloud server 602 having such intelligence programmed within. The system 600 can include a plurality of pad mounted transformers such as underground pad mounted transformers 600a, 600b, 600c, 600d having a high voltage primary input conductor and/or high voltage primary output conductors. In some embodiments, an AI fault detection analysis engine using the AI cloud server 602 can perform such analysis either using event triggers or polling techniques, which can monitor primary and second voltage and current waveforms as well as other waveforms which can be viewed on a client device, display or an oscilloscope. The additional data provided by the thermistor module and the Rogowski coils in this particular instance in such manner can also further help classify or categorize the types of faults that are detected and also provide a better fault location vector in order to pinpoint the locations of such fault on a more granular level. Calculations and/or measurements can be done for some or each transformer in the system 600. All the data collected would be transmitted either in a wired fashion or via a wireless connection.

The dash lines in FIGS. 7A and 7B are shown to reflect that a number of components that can belong to one system or another (DTM, thermistor module system, Rogowski coil system, other parameter sensor system, communication system, etc.), but the functionality is not limited to reside in one particular device or another.

The overall transmission system 700 of FIG. 7A or 7B in one embodiment can include a number of separate components or components that form a part of number of integrated devices that includes all or some of the functionality of the separate individual components shown that would monitor a transformer 702 such as an underground pad mounted transformer. For example, a DTM system 704 can include all or some of the components including a Rogowski coil system which can include a primary Rogowski coil or coils 703 a secondary Rogowski coil or coils 706 (which can further include voltage sensing), a mixed signal processor 708, a high-speed Analog to Digital converter 710, a power source 712 and a last gasp device 714. The DTM system 704 in some embodiments can further include a thermal sensor 720 such as a thermal camera or the thermistor module, a microcontroller 716, a communications module 722, and an accelerometer 718, such as a gravity sensor (G-sensor). Embodiments herein can further include an optical sensor 721.

In one embodiment, the mix signal processor can be processor belonging to an application-specific standard part (ASSP) family designed for high accuracy measurement of power and energies in power line systems using the Rogowski coil, current transformer or shunt current sensors. Such a processor can provide instantaneous voltage and current waveforms and calculate RMS values of voltage and currents, active, reactive and apparent power and energies. The processor 708 can be a mixed signal IC family consisting of an analog and a digital section. The analog section can consist of up to two programmable gain low-noise low-offset amplifiers and up to four 2^{nd} order 24-bit sigma-delta analog-to-digital converters (ADCs), two bandgap voltage references with independent temperature compensation, a low drop voltage regulator and DC buffers. The digital section consists of digital filtering stage, a hardwired DSP, DFE to the input and a serial communication interface (UART or SPI). In another embodiment, the system can use a separate device for an ADC in the form of ADC 710. The power source 712 can be anything from 480-110 AC or a 5V DC source or even less depending on the configuration. The last gasp device 714 is a device that is configured to record state information when power is lost. Such devices will typically record the information to flash memory or send out a wireless signal or both.

The system 700 or DTM system 704 can further include one or more accelerometers 718 coupled to the one or more processors (716) for detection of sudden movement of one or more transformers (702) among a plurality of transformers in the system 700. The accelerometer 718 as well as some of the other devices (such as the ADC 710 and Secondary Rogowski Coil with voltage sense 706) can be coupled to a microcontroller 716 such as the ST Microelectronics STM32 32-bit controller. The microcontroller 716 can send (or receive) the gathered data (from the microcontroller 716, thermal sensor 720, optical sensor 721, GPS, etc.) to a communication module 722 (e.g., modem) which supports communication via LTE and, when also configured for Global Navigation Satellite System (GNSS) applications, may receive GNSS data (such as GPS data) or other location data to a remote server. In some embodiments, the communication module 722 can include a global positioning system receiver and in other embodiments a separate GPS receiver can be coupled to at least one or more transformers among the plurality of transformers to detect any sudden movement or acceleration (earthquake, crash impact, lightning strike, etc.). In some embodiments, the system can further monitor and transmit at least a corresponding waveform or data representative of the waveform for at least one or more of the transformers in such a system using the parameter sensors or Rogowski coil or coils (and a waveform capturing and processing device or display) as previously described. The system would generally be configured to generate an alert when at least the corresponding waveform (or certain data) is beyond a predetermined deviation from a reference waveform (or from reference data).

In some embodiments, a distribution transformer monitoring device includes an optical sensor operable to generate an optical sensor output voltage in response to incident light, a communication interface, a non-transitory memory storing processor-executable instructions, and a processor, operably coupled to the optical sensor, the communication interface, and the memory. The processor can be operable in accordance with the processor-executable instructions to determine whether output data from the optical sensor substantially matches one of a plurality of optical sensor output data signatures representing corresponding event signatures and communicate via the communication interface an alert to a remote computing device when the output data substantially matches one of the plurality of optical sensor output data signatures.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a transformer monitoring apparatus may be described as being mounted “substantially vertical,” In these cases, a device that is mounted exactly vertical is mounted along a “Y” axis and a “X” axis that is normal (i.e., 90 degrees or at right angle) to a plane or line formed by a “Z” axis. Different from the exact precision of the term, “vertical,” and the use of “substantially” or “about” to modify the characteristic permits a variance of the particular characteristic by up to 30 percent.

The terms “include” and “comprise” as well as derivatives thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” or “some embodiments” and variations thereof mean that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

As the context may require in this disclosure, except as the context may dictate otherwise, the singular shall mean the plural and vice versa. Also, the masculine shall mean the feminine and vice versa.

When so arranged as described herein, each computing device may be transformed from a generic and unspecific computing device to a combination device comprising hardware and software configured for a specific and particular purpose. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The various embodiments described above can be combined to provide further embodiments. Aspects of the embodiments can be modified, if necessary to employ concepts of the various patents, application and publications to provide further embodiments.

What is claimed is:

1. An object temperature monitoring apparatus comprising:
a first housing configured for attachment to an object;
a thermistor module coupled to or integrated with the first housing, the thermistor module including:
a second housing that includes an elastic boot and a thermistor compartment adjacent to the elastic boot; and
a thermistor positioned within the thermistor compartment of the second housing and oriented to sense a temperature of the object when the first housing is attached to the object and the thermistor compartment is placed against a surface of the object.

2. The object temperature monitoring apparatus of claim 1, wherein the thermistor compartment of the second housing includes a window oriented for placement against the surface of the object.

3. The object temperature monitoring apparatus of claim 1, wherein the thermistor compartment of the second housing is filled with, and the thermistor is set within, an elastomeric potting that provides environmental protection, thermal conduction, and electrical isolation for the thermistor.

4. The object temperature monitoring apparatus of claim 1, wherein the elastic boot of the second housing is constructed to allow movement of the thermistor compartment when the thermistor compartment is compressed against the surface of the object to enable the thermistor compartment to form a seal against the surface of the object to prevent ambient air from affecting temperature measurements.

5. A thermistor module comprising:
a conforming housing that includes an elastic boot and a thermistor compartment adjacent to the elastic boot; and
a thermistor positioned within the thermistor compartment of the conforming housing and oriented to sense a temperature of an object against which the thermistor compartment is to be placed.

6. The thermistor module of claim 5, wherein the thermistor compartment of the conforming housing includes a window oriented for placement against a surface of the object.

7. The thermistor module of claim 6, wherein the window is translucent or transparent.

8. The thermistor module of claim 6, wherein the thermistor compartment is filled with, and the thermistor is set within, an elastomeric potting that provides environmental protection, thermal conduction, and electrical isolation for the thermistor.

9. The thermistor module of claim 5, wherein the thermistor compartment is filled with, and the thermistor is set within, an elastomeric potting that provides environmental protection, thermal conduction, and electrical isolation for the thermistor.

10. The thermistor module of claim 5, wherein the thermistor compartment provides an auto-sealing function under compression to prevent ambient air from affecting temperature measurements.

11. The thermistor module of claim 5, further comprising:
cabling to couple the thermistor to electrical circuitry in a monitoring device in or with which the thermistor module is used.

12. The thermistor module of claim 5, wherein the elastic boot is constructed to allow movement of the thermistor compartment when compressed against the object to enable the thermistor compartment to form a seal against a surface of the object to prevent ambient air from affecting temperature measurements.

13. The thermistor module of claim 5, wherein the object is an electrical distribution transformer.

14. A transformer monitoring apparatus comprising:
a first housing configured for attachment to an electrical distribution transformer;
a thermistor module coupled to or integrated with the first housing, the thermistor module including:
a second housing that includes an elastic boot and a thermistor compartment adjacent to the elastic boot; and
a thermistor positioned within the thermistor compartment of the second housing and oriented to sense a temperature of the electrical distribution transformer when the first housing is attached to the electrical distribution transformer and the thermistor compartment is placed against a surface of the electrical distribution transformer.

15. The transformer monitoring apparatus of claim 14, wherein the thermistor compartment of the second housing includes a window oriented for placement against the surface of the electrical distribution transformer.

16. The transformer monitoring apparatus of claim 15, wherein the window is translucent or transparent.

17. The transformer monitoring apparatus of claim 14, wherein the thermistor compartment of the second housing is filled with, and the thermistor is set within, an elastomeric potting that provides environmental protection, thermal conduction, and electrical isolation for the thermistor.

18. The transformer monitoring apparatus of claim 14, wherein the thermistor compartment of the second housing provides an auto-sealing function under compression to prevent ambient air from affecting temperature measurements.

19. The transformer monitoring apparatus of claim 14, wherein the thermistor module further includes cabling running from the thermistor through at least the elastic boot to couple the thermistor to electrical circuitry in the first housing.

20. The transformer monitoring apparatus of claim 14, wherein the elastic boot of the second housing is constructed to allow movement of the thermistor compartment when the thermistor compartment is compressed against the surface of the electrical distribution transformer to enable the thermistor compartment to form a seal against the surface of the electrical distribution transformer to prevent ambient air from affecting temperature measurements.
